(19) United States
(12) Patent Application Publication
(10) Pub. No.: US 2009/0027647 A1
(43) Pub. Date: Jan. 29, 2009

(54) EXPOSURE APPARATUS AND DEVICE FABRICATION METHOD

(75) Inventors: Yoshiyuki Nagai, Utsunomiya-shi (JP); Kazuhiro Takahashi, Utsunomiya-shi (JP); Akihiro Yamada, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/172,298

(22) Filed: Jul. 14, 2008

(30) Foreign Application Priority Data
Jul. 24, 2007 (JP) 2007-192649

(51) Int. Cl. G03B 27/72

(52) U.S. Cl. 355/69

(57) ABSTRACT

The present invention provides an exposure apparatus comprising an illumination optical system configured to illuminate a reticle including a pellicle with light from a light source, a projection optical system configured to project a pattern of the reticle onto a substrate, an obtaining unit configured to obtain information on a thickness of the pellicle, an adjusting unit configured to adjust an illuminance on the substrate, and a control unit configured to control the adjusting unit based on the information on the thickness of the pellicle obtained by the obtaining unit.

### BACKGROUND OF THE INVENTION

1. Field of the Invention

The present invention relates to an exposure apparatus and a device fabrication method.

2. Description of the Related Art

A projection exposure apparatus which projects and transfers a circuit pattern formed on a reticle (mask) onto a substrate such as a wafer via a projection optical system has conventionally been employed to fabricate a semiconductor device by using photolithography.

A minimum line width (resolution) that the projection exposure apparatus can transfer is proportional to the exposure light wavelength and is inversely proportional to the numerical aperture (NA) of the projection optical system. Along with the recent demand for micropatterning semiconductor devices, the exposure light wavelength is shortening and the NA of the projection optical system is increasing. Nowadays, a further increase in the NA of the projection optical system is attained by the so-called immersion method which fills the space between the wafer and the final surface (final lens surface) of the projection optical system with a liquid (e.g., pure water). In addition, several illuminance variation correction techniques have conventionally been proposed to meet a demand that the projection exposure apparatus increase the illuminance uniformity (i.e., reduce an illuminance variation) on the wafer. See Japanese Patent Laid-Open Nos. 62-193125, 7-37774, and 11-312639 for details of these techniques. In accordance with a pattern formed by a light-shielding part which shields exposure light and a light-transmitting part which transmits it, the projection exposure apparatus splits exposure light which has entered the reticle into transmitted light and diffracted light which contains information on the pattern. When the reticle pattern has periodicity,

P·sin θ=mλ (m: the order of diffracted light) (1)

where λ is the exposure light wavelength, P is the pattern pitch, and θ is the angle of diffraction on (the pattern of) the reticle.

In view of this, if exposure light has the same wavelength, the angle of diffraction of light diffracted by the pattern increases as the reticle pattern pitch decreases.

A pellicle is attached near a reticle pattern surface (a surface on which a pattern is formed) via a pellicle frame in order to prevent dirt or foreign substances (particles) such as dust from adhering to the pattern surface. The pellicle is formed from a thin transparent film and is positioned spaced apart from the reticle pattern surface by about 4 mm to 7 mm. Note that providing the pellicle on the reticle is known to have an adverse influence on the optical performances of the projection exposure apparatus. See Japanese Patent Laid-Open No. 2002-50558 for details of this reason.

For example, the pellicle has a property that its transmittance changes depending on the light incident angle. As the angle of diffraction of diffracted light increases along with reticle micropatterning, the angle (the incident angle with respect to the pellicle) at which light enters the pellicle also increases, resulting in a significant change in transmittance. To reduce the change in transmittance, a pellicle with a thickness of about 0.5 μm is under development.

Unfortunately, the thickness of the pellicle is not perfectly uniform in a region used for exposure (exposure region), so it has a thickness distribution (thickness variation) due to, for example, its manufacturing errors. More specifically, the pellicle has a thickness variation of about 1% to 2% with respect to a design value in its exposure region.

FIG. 8 is a graph showing the light transmittance when the pellicle is irradiated with light with a specific wavelength. The abscissa indicates the light incident angle [°] with respect to the pellicle, and the ordinate indicates the light transmittance [%]. FIG. 8 shows a case in which the pellicle has a thickness matching a design value (has no thickness variation) (solid curve A), a case in which the pellicle has a thickness variation of 1.0% with respect to the design value (dotted curve B), and a case in which the pellicle has a thickness variation of 2.0% with respect to the design value (dotted curve C).

The projection optical system often has a magnification of ¼ in the recent projection exposure apparatus of the step & scan scheme. In forming a pattern with a relatively small line width by exposure to fabricate a leading-edge semiconductor device, the angle at which light enters the pellicle is about 20°. If the pellicle has a thickness variation in its exposure region, the intensity of light transmitted through the pellicle changes due to a change in transmittance with respect to the incident angle (see FIG. 8). Consequently, even when the illumination optical system, projection optical system, and reticle are free from factors that give rise to a line width difference (pattern difference), the illuminance on the wafer becomes nonuniform, resulting in a line width difference due to a thickness variation of the pellicle.

In this manner, the thickness variation of the pellicle has an adverse influence on the optical performances (e.g., the resolving power) of the projection exposure apparatus. Conventionally, because the line width of the reticle pattern is relatively large with respect to the exposure light wavelength, the angle at which light diffracted by the reticle pattern enters the pellicle is not so large. Therefore, the adverse influences, on the optical performances of the projection exposure apparatus, of a change in transmittance due to a thickness variation of the pellicle and a difference in transmittance attributed to the light incident angle with respect to the pellicle are negligible. However, as the incident angle of diffracted light with respect to the pellicle increases along with reticle micropatterning, the influences of a change and difference in transmittance of the pellicle on the optical performances of the projection exposure apparatus are becoming non-negligible.

FIG. 9 is a graph showing a change in line width when the reticle pattern pitch is changed. In the graph shown in FIG. 9, the ordinate indicates the line width difference (ΔCD) [nm] when compared to a case in which the pellicle has no thickness variation, and the abscissa indicates the reticle pattern pitch [μm]. This reticle pattern pitch is defined as a value obtained by multiplying the pattern pitch on the reticle by the projection magnification, and converting the pattern pitch on the reticle into that on the wafer. FIG. 9 shows a case in which the pellicle has a thickness matching a design value (has no thickness variation) (solid curve D), a case in which the pellicle has a thickness variation of 1.0% with respect to the design value (dotted curve E), and a case in which the pellicle has a thickness variation of 2.0% with respect to the design value (dotted curve F).

Referring to FIG. 9, if the pellicle has a thickness variation, the line width difference when compared to a case in which the pellicle has no thickness variation is large when the reticle pattern pitch is small. This phenomenon is attributed to a change in transmittance of exposure light (i.e., a change in illuminance on the wafer) due to a change in thickness of the pellicle. The line width difference shown in FIG. 9 is non-negligible in fabricating a leading-edge semiconductor device.

The pellicle is a component (extendable) replaced when dirt adheres on it or when its material deteriorates. Even when the pellicle is replaced, optical performances necessary for the projection exposure apparatus must always be achieved.

### SUMMARY OF THE INVENTION

The present invention provides an exposure apparatus which can reduce line width nonuniformity due to a thickness variation of a pellicle.

According to one aspect of the present invention, there is provided an exposure apparatus comprises an illumination optical system configured to illuminate a reticle including a pellicle with light from a light source, a projection optical system configured to project a pattern of the reticle onto a substrate, an obtaining unit configured to obtain information on a thickness of the pellicle, an adjusting unit configured to adjust an illuminance on the substrate, and a control unit configured to control the adjusting unit based on the information on the thickness of the pellicle obtained by the obtaining unit.

According to another aspect of the present invention, there is provided a device fabrication method comprises steps of exposing a substrate using the above exposure apparatus, and performing a development process for the substrate exposed.

Further features of the present invention will become apparent from the following description of exemplary embodiments with reference to the attached drawings.

### BRIEF DESCRIPTION OF THE DRAWINGS

FIG. 1 is a schematic block diagram showing an exposure apparatus according to one aspect of the present invention.

FIG. 2 is a view showing the arrangement of a variable aperture stop as a concrete example of an illuminance adjusting unit of the exposure apparatus shown in FIG. 1.

FIG. 3 is a view showing an example of the detailed arrangement of a measuring unit of the exposure apparatus shown in FIG. 1.

FIG. 4 is a chart showing an example of the light reception result obtained by a light-receiving unit of the measuring unit of the exposure apparatus shown in FIG. 1.

FIG. 5 is a diagram for explaining an example of the measurement (calculation) of the thickness of a pellicle by the measuring unit of the exposure apparatus shown in FIG. 1.

FIG. 6 is a diagram for explaining the correction (adjustment) of the illuminance distribution (i.e., the illuminance distribution on a wafer) on a reticle pattern surface.

FIG. 7 is a flowchart for explaining the exposure operation of the exposure apparatus shown in FIG. 1.

FIG. 8 is a graph showing the light transmittance when the pellicle is irradiated with light.

FIG. 9 is a graph showing a change in line width when the reticle pattern pitch is changed.

### DESCRIPTION OF THE EMBODIMENT

A preferred embodiment of the present invention will be described below with reference to the accompanying drawings. The same reference numerals denote the same members throughout the drawings, and a repetitive description thereof will not be given.

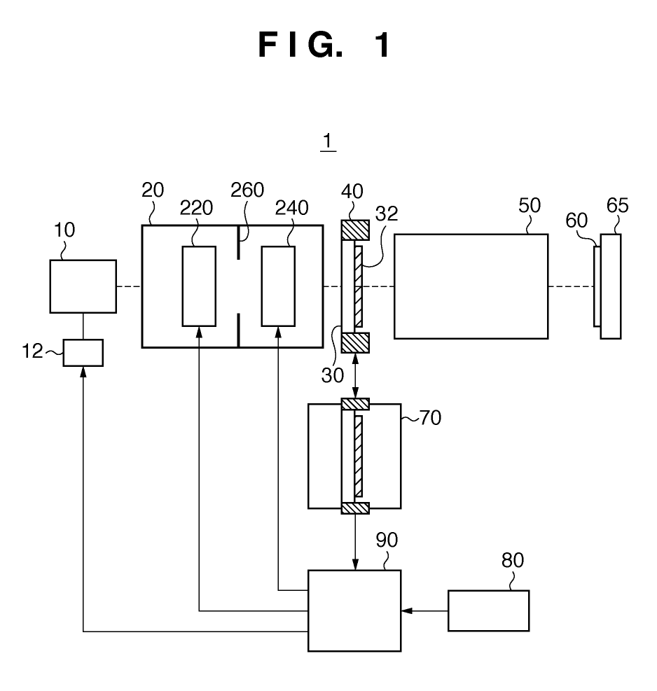

FIG. 1 is a schematic block diagram showing the arrangement of an exposure apparatus 1 according to one aspect of the present invention. In this embodiment, the exposure apparatus 1 is a projection exposure apparatus which transfers the pattern of a reticle 30 onto a wafer 60 as a substrate by exposure using the step & scan scheme. The exposure apparatus 1 exposes each shot region with slit-like exposure light while relatively scanning the reticle 30 and the wafer 60. However, the exposure apparatus 1 can adopt the step & repeat scheme or another exposure scheme.

As shown in FIG. 1, the exposure apparatus 1 includes a light source 10, an illumination optical system 20, a reticle stage 40 for supporting the reticle 30, a projection optical system 50, a wafer stage 65 for supporting the wafer 60, a measuring unit 70, an input unit 80, and a control unit 90.

The light source 10 is, for example, a laser such as a KrF excimer laser with a wavelength of about 248 nm or an ArF excimer laser with a wavelength of about 193 nm. The light source 10 includes a changing unit 12 for changing the energy or oscillation frequency of light to emit under the control of the control unit 90. Also, the light source 10 performs, for example, the exchange of a laser gas serving as a laser medium, and the adjustment of the light quality (e.g., the oscillation wavelength and pulse energy) in maintenance.

The illumination optical system 20 illuminates the reticle 30 with light from the light source 10. In this embodiment, the illumination optical system 20 includes an illuminance adjusting unit 220 for adjusting the illuminance distribution (i.e., the illuminance on the wafer 60 (on the substrate)) on the pattern surface of the reticle 30, and an effective light source shape adjusting unit 240 for adjusting the incident angle distribution (i.e., the effective light source shape) of exposure light with respect to the reticle 30. At a position that is optically conjugate to the reticle 30, the illumination optical system 20 also includes a masking blade 260 for limiting the exposure range on the reticle 30. The illumination optical system 20 illuminates the reticle 30 under desired illumination conditions via the illuminance adjusting unit 220 and effective light source shape adjusting unit 240.

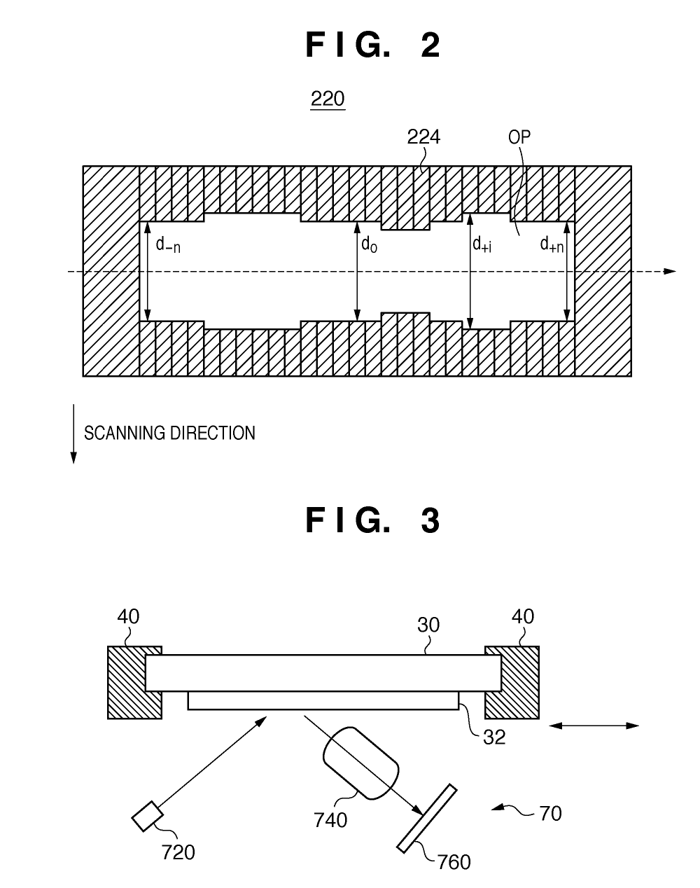

A concrete example of the illuminance adjusting unit 220 will be explained. For example, the illuminance adjusting unit 220 is implemented as a variable aperture stop having a plurality of light-shielding plates 224 and an opening OP whose shape and size are variable, as shown in FIG. 2. The variable aperture stop is inserted in the light path of the illumination optical system 20. The plurality of light-shielding plates 224 are light-shielding members which shield light from the light source 10, and define the shape and size of the opening OP which passes the light from the light source 10. The plurality of light-shielding plates 224 can be driven in at least a direction parallel to the scanning direction under the control of the control unit 90. In this embodiment, the variable aperture stop serving as the illuminance adjusting unit 220 includes (2n+1) light-shielding plates 224, and their positions correspond to respective object heights on the reticle 30. The light-shielding plates 224 can independently determine (set) opening widths di in a direction parallel to the scanning direction. Note that FIG. 2 is a view showing the arrangement of a variable aperture stop as a concrete example of the illuminance adjusting unit 220.

The reticle 30 has a pattern (circuit pattern) formed by a light-shielding part which shields light (exposure light) from the light source 10 and a light-transmitting part which transmits it, and is supported and driven by the reticle stage 40. The light-shielding part is mainly made of a material such as chromium. The reticle 30 includes, via a pellicle frame (not shown), a pellicle 32 for protecting the pattern (a surface on which a pattern is formed) of the reticle 30 from ambient foreign substances (particles) such as dust. The pellicle 32 is formed from, for example, a thin organic film to prevent particles from adhering on the pattern.

The reticle stage 40 supports the reticle 30 and drives it in at least a direction (scanning direction) perpendicular to the optical axis using, for example, a linear motor.

The projection optical system 50 projects the pattern of the reticle 30 onto the wafer 60. The projection optical system 50 forms an image of light (i.e., an image of the pattern of the reticle 30), which has passed through the pattern of the reticle 30, on the wafer 60 at a predetermined magnification. The projection optical system 50 can be a dioptric system, catadioptric system, or catoptric system.

The wafer 60 is a substrate onto which the pattern of the reticle 30 is projected (transferred). However, the wafer 60 can be substituted by a glass plate or another substrate. The wafer 60 is coated with a photoresist.

The wafer stage 65 supports the wafer 60 and drives it in a direction (scanning direction) perpendicular to the optical axis and a direction parallel to the optical axis using, for example, a linear motor. Also, the wafer stage 65 can tilt the wafer 60 with respect to the optical axis.

The measuring unit 70 has a function of measuring the thickness of the pellicle 32 attached on the reticle 30. In this embodiment, the measuring unit 70 measures the thickness (thickness variation (thickness distribution)) of the pellicle 32 over its entire region used for exposure (exposure region). In other words, the measuring unit 70 serves as an obtaining unit which obtains information on the thickness of the pellicle 32. Also in this embodiment, the measuring unit 70 measures the thickness of the pellicle 32 attached on the reticle 30, while the reticle 30 is supported by the reticle stage 40. This makes it possible to measure the thickness of the pellicle 32 under the same conditions as in actual exposure. The measuring unit 70 outputs the measurement result (i.e., the thickness of the pellicle 32 obtained by the measuring unit 70) to the control unit 90.

A detailed example of the measuring unit 70 will be explained. As shown in FIG. 3, the measuring unit 70 includes a light emitting unit 720 having a light source such as a laser, an enlargement optical system 740 for improving the resolution, and a light-receiving unit 760 having a light-receiving element such as a line sensor or CCD. The reticle 30 having the pellicle 32 is loaded into the measuring unit 70 while being supported by the reticle stage 40. Note that FIG. 3 is a view showing an example of the detailed arrangement of the measuring unit 70.

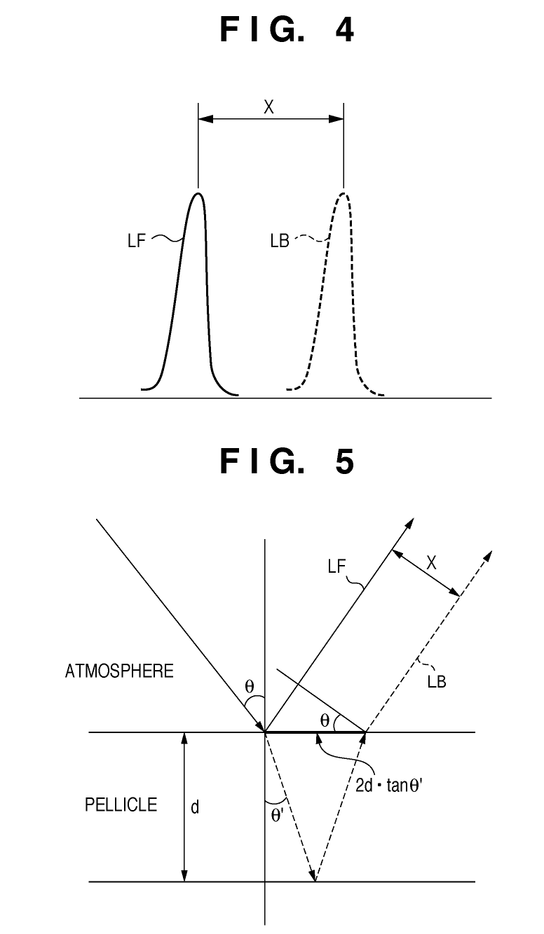

Referring to FIG. 3, light emitted by the light emitting unit 720 enters the pellicle 32 at a predetermined angle, is reflected by the pellicle 32, and is received by the light-receiving unit 760. As shown in FIG. 4, both light components LF and LB reflected by the upper and lower surfaces, respectively, of the pellicle 32 are observed in the light-receiving unit 760. The measuring unit 70 can measure (calculate) the thickness of the pellicle 32 by calculating a distance X between the intensity peaks of the light components LF and LB. Note that FIG. 4 is a chart showing an example of the light reception result obtained by the light-receiving unit 760 of the measuring unit 70.

An example of the measurement (calculation) of the thickness of the pellicle 32 by the measuring unit 70 will be explained in detail with reference to FIG. 5. This embodiment will exemplify a case in which light emitted by the light emitting unit 720 enters a pellicle 32 with a refractive index n and thickness d at an incident angle θ from the atmosphere, is reflected by the upper and lower surfaces of the pellicle 32, and is received by the light-receiving unit 760.

In FIG. 5, based on the Snell's law, the incident angle θ and an angle θ′ of refraction satisfy:

sin θ=n×sin θ′ (2)

It is therefore possible to calculate the angle θ′ of refraction when the refractive index n and incident angle θ of the pellicle 32 are determined.

A positional shift amount x between the light components LF and LB reflected by the upper and lower surfaces, respectively, of the pellicle 32 is given by:

x=2d·tan θ′·cos θ (3)

The positional shift amount x is also given by:

x=X/M (4)

where M is the magnification of the enlargement optical system 740, and X is the distance between the intensity peaks of the light components LF and LB shown in FIG. 4.

Referring to expressions (3) and (4), since the incident angle θ, the angle θ of refraction, the refractive index n of the pellicle 32, and the magnification M of the enlargement optical system 740 are known, the thickness d of the pellicle 32 can be calculated by calculating the distance X between the intensity peaks of the light components LF and LB.

In this manner, the measuring unit 70 measures the thickness (thickness variation) of the pellicle 32 over its entire surface. In this embodiment, the measuring unit 70 measures the thickness of the pellicle 32 over its entire surface while driving the reticle 30 via the reticle stage 40. However, the measuring unit 70 may have a unit in which the enlargement optical system 740 and light-receiving unit 760 are integrated, and measure the thickness of the pellicle 32 by driving this unit parallel to the pellicle 32.

The number of measurement points at which the measuring unit 70 measures the thickness of the pellicle 32 is preferably equal to or more than the number (2n+1 in this embodiment) of light-shielding plates 224 of the variable aperture stop serving as the illuminance adjusting unit 220.

In this embodiment, the measuring unit 70 measures the thickness of the pellicle 32 with light components reflected by the upper and lower surfaces of the pellicle 32. However, the present invention is not particularly limited to the arrangement shown in FIG. 3 as long as the measuring unit 70 can measure the thickness of the pellicle 32 with high precision.

Referring back to FIG. 1, the input unit 80 is an interface for inputting conditions (exposure conditions) necessary for exposure and information from the outside. Since the thickness (thickness variation) of the pellicle 32 measured using even an external measuring apparatus of the exposure apparatus 1 can be input via the input unit 80, the input unit 80 also serves as an obtaining unit which obtains information on the thickness of the pellicle 32. In this case, the exposure apparatus 1 need not include the measuring unit 70 which measures the thickness of the pellicle 32. Information (e.g., the exposure conditions and the thickness of the pellicle 32) input via the input unit 80 is output to the control unit 90.

The control unit 90 includes a CPU and memory (not shown) and controls the operation of the exposure apparatus 1. In this embodiment, the control unit 90 controls the illuminance adjusting unit 220 based on the measurement result (i.e., the thickness of the pellicle 32 measured by the measuring unit 70) obtained by the measuring unit 70, or the thickness of the pellicle 32 input via the input unit 80.

First, the control unit 90 calculates the transmittance (transmittance distribution) of the pellicle 32 with respect to the exposure light over its entire exposure region based on the thickness of the pellicle 32 at each point in its exposure region, and the exposure conditions (the illumination conditions and the NA of the projection optical system 50). The transmittance of the pellicle 32 with respect to the exposure light is calculated using the thickness d of the pellicle 32, and the incident angle θ of the exposure light with respect to the pellicle 32. In actual exposure, the incident angle θ of the exposure light with respect to the pellicle 32 is not given by a single value, and it has a predetermined distribution. The transmittance of the pellicle 32 at a certain position is:

∫f(d, θ)dθ (5)

where f(d, θ) is the transmittance angle characteristic function of the pellicle 32. Note that the integration shown in expression (5) is performed based on an exposure condition (the incident angle distribution of the exposure light with respect to the reticle 30) determined in advance.

Next, the control unit 90 controls the shape and size of the opening OP defined by the plurality of light-shielding plates 224 of the variable aperture stop serving as the illuminance adjusting unit 220, so that the illuminance on the wafer 60 becomes uniform. In other words, the control unit 90 corrects (adjusts) the illuminance distribution (i.e., the illuminance distribution on the wafer) on the pattern surface of the reticle 30 based on the thickness of the pellicle 32.

More specifically, the control unit 90 calculates an illuminance distribution I (an illuminance I1 at each point in the exposure region) on the pattern surface of the reticle 30 while the reticle 30 is not mounted on the reticle stage 40. As described above, a transmittance T1 of the pellicle 32 at each point in its exposure region under predetermined exposure conditions is calculated using expression (5). The final illuminance at each point in the exposure region on the pellicle 32 is I1×T1=E1. Let E0 be the final illuminance at an on-axis position, d0 be the opening width of the opening OP defined by the light-shielding plate 224 positioned at the center of the variable aperture stop, E1 be the illuminance at each position in a direction perpendicular to the scanning direction, and di be the opening width of the opening OP at that position. Then, when the control unit 90 controls the opening width of the opening OP defined by the light-shielding plates 224 to satisfy E0×d0=E1×di, the illuminance on the wafer 60 can be uniformed by reducing an illuminance variation for each image height.

Consider a case in which exposure is performed while scanning the reticle 30 via the reticle stage 40. In this case, letting E0×d0 (t1) be the transmittance at an on-axis position at time t1, and E0×d0 (t2) be the transmittance at the on-axis position at time t2, the illuminance adjusting unit 220 (the opening width d0 of the opening OP defined by the light-shielding plate 224) is controlled to satisfy E0×d0 (t1)=E0×d0 (t2).

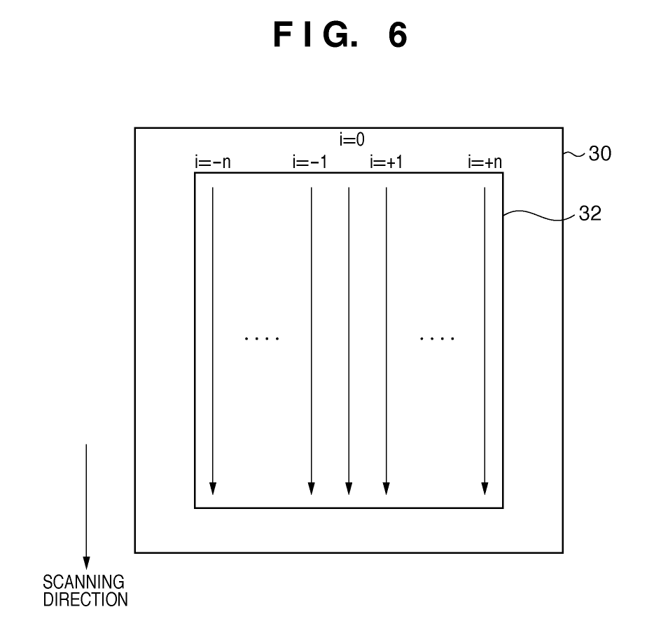

When exposure is performed while scanning the reticle 30, a sufficient time to control (adjust) the opening width d0 of the opening OP defined by the light-shielding plate 224 cannot sometimes be secured (i.e., the control of the opening width d0 of the opening OP defined by the light-shielding plates 224 sometimes fails). In this case, the product E1×di of the illuminance E1 and the opening width di at each position is calculated in advance for respective image heights from −n to +n while moving the reticle 30 in the direction indicated by an arrow shown in FIG. 6, and then it is confirmed whether the respective values fall within an allowable range. Note that FIG. 6 is a diagram for explaining the correction (adjustment) of the illuminance distribution (i.e., the illuminance distribution on the wafer) on the pattern surface of the reticle 30.

If merely controlling the variable aperture stop (the opening width of the opening OP) serving as the illuminance adjusting unit 220 is insufficient to uniform the illuminance distribution (i.e., the illuminance distribution on the wafer) on the pattern surface of the reticle 30, the output from the light source 10 is controlled via the changing unit 12. More specifically, the control unit 90 controls the output from the light source 10 so that each shot region is exposed with a uniform exposure amount during the scanning exposure of the reticle 30 and the wafer 60. The control unit 90 controls the pulse energy and oscillation frequency of light, which is emitted by the light source 10, for each pulse.

In this embodiment, the illuminance on the wafer 60 is uniformed by controlling the illuminance adjusting unit 220 (the opening width of the opening OP) and/or the output from the light source 10 based on the thickness of the pellicle 32. However, the illuminance on the wafer 60 may be uniformed by controlling other optical members, which adjust the illuminance on the wafer 60, based on the thickness of the pellicle 32.

The control unit 90 may control the effective light source shape adjusting unit 240 based on the measurement result (i.e., the thickness of the pellicle 32 measured by the measuring unit 70) obtained by the measuring unit 70, or the thickness of the pellicle 32 input via the input unit 80. This makes it possible to determine satisfactory exposure conditions even when the reticle 30 has a pattern in which dense patterns and isolated patterns mix with each other. The effective light source shape required to control the effective light source shape adjusting unit 240 can be calculated using, for example, commonly-used optical image computation software.

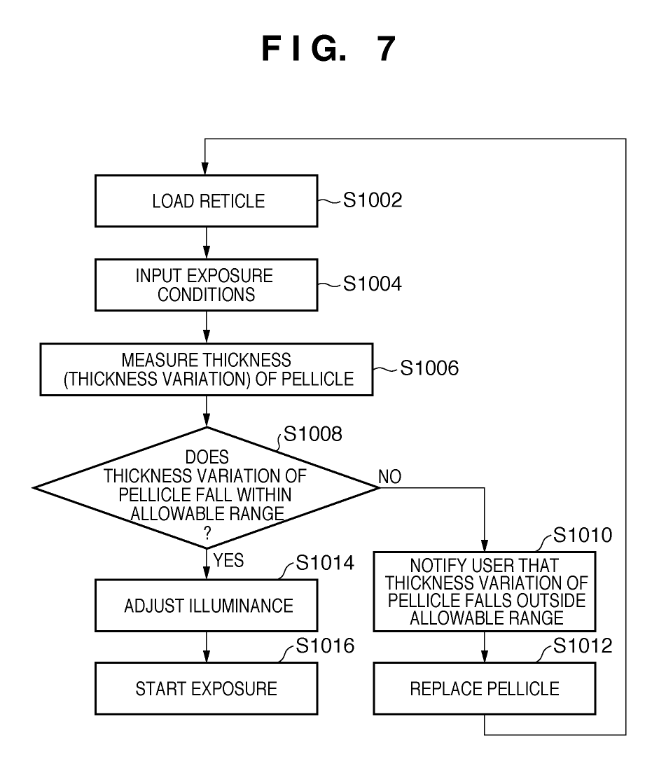

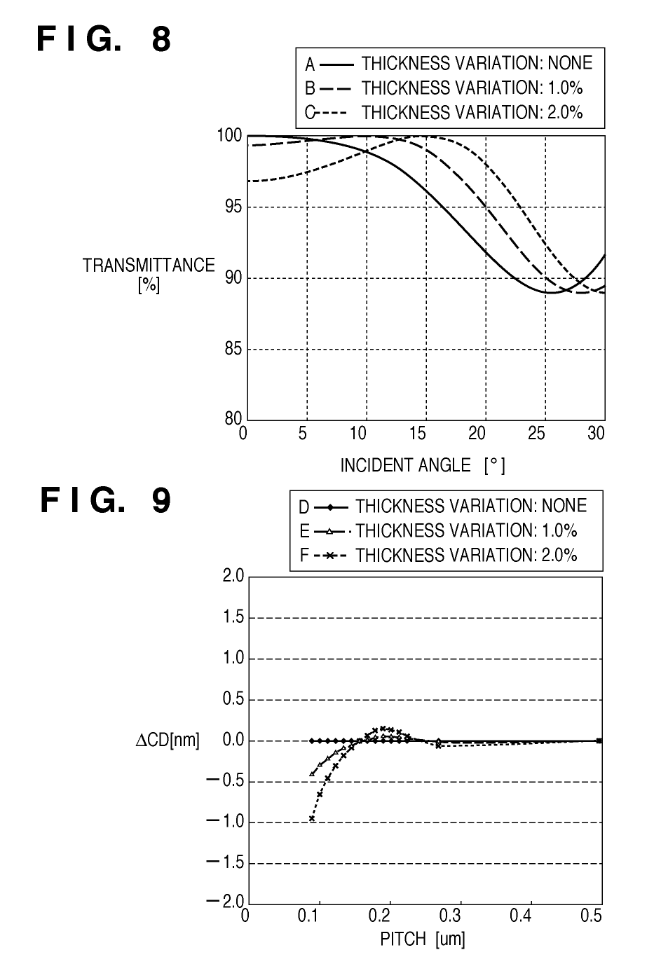

The exposure operation (especially, the adjustment of the illuminance on the wafer 60) of the exposure apparatus 1 will be explained with reference to FIG. 7.

In step S1002, a reticle 30 used for exposure is loaded into the exposure apparatus 1 and set on the reticle stage 40. A pellicle 32 is attached on the reticle 30 via a pellicle frame.

In step S1004, exposure conditions are input via the input unit 80. The thickness of the pellicle 32 measured by an external measuring apparatus of the exposure apparatus 1 may be input, together with the exposure conditions.

In step S1006, the reticle 30 is loaded into the measuring unit 70 while being supported by the reticle stage 40, and the thickness (thickness variation) of the pellicle 32 is measured. At this time, the thickness (thickness variation) of the pellicle 32 is measured over its entire exposure region.

In step S1008, it is determined whether the thickness variation of the pellicle 32 falls within an allowable range. In this embodiment, the illuminance adjustment range of the illuminance adjusting unit 220 is set as the allowable range. For this reason, if an illuminance variation on the wafer 60 due to a thickness variation of the pellicle 32 can be corrected (i.e., the illuminance on the wafer 60 can be uniformed) via the illuminance adjusting unit 220, it is determined that the thickness variation of the pellicle 32 falls within the allowable range. If an illuminance variation on the wafer 60 due to a thickness variation of the pellicle 32 cannot be corrected, it is determined that the thickness variation of the pellicle 32 falls outside the allowable range. If the illuminance adjusting unit 220 can adjust an illuminance variation up to a range allowable from the viewpoint of the fabrication of a semiconductor device although it cannot perfectly, uniformly adjust the illuminance on the wafer 60, it may be determined that the thickness variation of the pellicle 32 falls within the allowable range.

If it is determined that the thickness variation of the pellicle 32 falls outside the allowable range, in step S1010 the user is notified that the thickness variation of the pellicle 32 falls outside the allowable range. In step S1012, the reticle 30 is unloaded from the exposure apparatus 1, and the pellicle 32 attached on the reticle 30 is replaced with a new one. The process returns to step S1002.

If it is determined that the thickness variation of the pellicle 32 falls within the allowable range, in step S1014 the illuminance on the wafer 60 is adjusted by controlling the illuminance adjusting unit 220 based on the thickness (thickness variation) of the pellicle 32. With this operation, the illuminance variation on the wafer 60 due to the thickness variation of the pellicle 32 can be corrected, and the exposure apparatus 1 can therefore achieve excellent optical performances. The effective light source shape adjusting unit 240 may be controlled based on the thickness (thickness variation) of the pellicle 32 as needed, so that optimal exposure conditions are ensured.

As the illuminance on the wafer 60 is adjusted (corrected), exposure is started in step S1016. In the exposure, a light beam emitted by the light source 10 illuminates the reticle 30 by the illumination optical system 20. A light component reflecting the pattern of the reticle 30 forms an image on the wafer 60 by the projection optical system 50. At this time, the exposure apparatus 1 adjusts (corrects) the illuminance on the wafer 60 to be uniform based on the thickness (thickness variation) of the pellicle 32. Hence, the exposure apparatus 1 can provide devices (e.g., a semiconductor device, an LCD device, an image sensing device (e.g., a CCD), and a thin-film magnetic head) with high throughput, high quality, and a good economical efficiency. These devices are fabricated by a step of exposing a substrate (e.g., a wafer or glass plate) coated with a resist (photosensitive agent) using the exposure apparatus 1, a step of developing the exposed substrate, and other known steps.

According to this embodiment, the exposure apparatus 1 can achieve excellent optical performances even when the pellicle 32 has a thickness variation or it is replaced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-192649 filed on Jul. 24, 2007, which is hereby incorporated by reference herein in its entirety.

What is claimed is:

1. An exposure apparatus comprising:
an illumination optical system configured to illuminate a reticle including a pellicle with light from a light source;
a projection optical system configured to project a pattern of the reticle onto a substrate;
an obtaining unit configured to obtain information on a thickness of the pellicle;
an adjusting unit configured to adjust an illuminance on the substrate; and
a control unit configured to control said adjusting unit based on the information on the thickness of the pellicle obtained by said obtaining unit.

2. The apparatus according to claim 1, wherein said obtaining unit includes a measuring unit configured to measure the thickness of the pellicle.

3. The apparatus according to claim 1, wherein said obtaining unit includes an input unit configured to input the thickness of the pellicle.

4. The apparatus according to claim 1, wherein
said adjusting unit includes a variable aperture stop which is inserted in a light path of said illumination optical system and has an opening whose shape and size are variable, and
said control unit controls the size and shape of said opening so that the illuminance on the substrate becomes uniform.

5. The apparatus according to claim 1, wherein
said exposure apparatus exposes each shot region with slit-like exposure light while relatively scanning the reticle and the substrate,
said adjusting unit includes a changing unit configured to change an output from the light source, and
said control unit controls the output from the light source so that said each shot region is exposed with a uniform exposure amount during the scanning exposure of the reticle and the substrate.

6. The apparatus according to claim 5, wherein said changing unit changes at least one of energy and an oscillation frequency of the light from the light source.

7. The apparatus according to claim 1, wherein the information on the thickness of the pellicle includes a thickness distribution of the pellicle.

8. A device fabrication method comprising steps of:
exposing a substrate using an exposure apparatus according to claim 1; and
performing a development process for the substrate exposed.
